(19) United States
(12) Patent Application Publication
(10) Pub. No.: US 2002/0022686 A1
(43) Pub. Date: Feb. 21, 2002

(54) Thermoplastic resin composition

(76) Inventors: Hiroyuki Itoh, Tokyo (JP); Hiroaki Miyazaki, Tokyo (JP); Keigo Higaki, Tokyo (JP); Masahiko Noro, Tokyo (JP)

Correspondence Address: NIXON & VANDERHYE P.C., 1100 North Glebe Road, 8th Floor, Arlington, VA, 22201, US

(21) Appl. No.: 09/878,906

(22) Filed: Jun. 13, 2001

(30) Foreign Application Priority Data
Jun. 15, 2000 (JP) 2000-180385

(51) Int. Cl. C08L 51/00

(52) U.S. Cl. 524/504

(57) ABSTRACT

The present invention relates to thermoplastic resin composition comprising:

100 parts by weight of a thermoplastic resin containing (A) 5 to 60 parts by weight of a rubber-reinforced resin comprising a graft copolymer produced by polymerizing at least one monomer component (b) selected from the group consisting of aromatic vinyl compounds, cyanided vinyl compounds, acrylate or methacrylate compounds, acid anhydride monomer compounds and maleimide-based compounds in the presence of a rubber-like polymer (a), or a mixture of the graft copolymer with polymers or copolymers of the monomer component (b), said rubber-reinforced resin comprising 5 to 60% by weight of the rubber-like polymer (a) and 40 to 95% by weight of the monomer component (b) with the proviso that the total amount of the components (a) and (b) is 100% by weight, and (B) 40 to 95 parts by weight of an aromatic polycarbonate with the proviso that the total amount of the components (A) and (B) is 100 parts by weight;

(C) 1 to 30 parts by weight of a flame retardant based on 100 parts by weight of the components (A) and (B);

(D) 0.1 to 20 parts by weight of a flame retardant assistant based on 100 parts by weight of the components (A) and (B); and

(E) 1 to 30 parts by weight of a PAN-based carbon fiber based on 100 parts by weight of the components (A) and (B).

### BACKGROUND OF THE INVENTION

The present invention relates to a thermoplastic resin composition. More particularly, it relates to a thermoplastic resin composition comprising a rubber-reinforced resin, an aromatic polycarbonate, a flame retardant, a flame retardant assistant and a PAN-based carbon fiber which thermoplastic resin composition is excellent in stiffness, flame retardancy, fluidity and impact resistance (surface-impact resistance), and capable of forming a molded product having an excellent appearance.

Flame retardant resin materials such as flame retardant ABS/polycarbonate resin alloy materials have been extensively used as housings for personal computers, PPC parts or the like. In particular, with recent tendency toward reduction in thickness of notebook-type personal computers, it has been required that materials used for housings thereof exhibit a high stiffness even when formed into a thin-wall product. In order to obtain a thin-wall product having a high stiffness, glass fibers have been usually incorporated in the resin materials. However, molded products containing such glass fibers suffer from defective appearance along its weld line (especially concaves at weld portions), thereby inevitably requiring an additional step of polishing the surface of the molded product.

As a result of the present inventors' earnest studies to solve the above problem, it has been found that the thermoplastic resin composition containing a rubber-reinforced resin, an aromatic polycarbonate, a flame retardant, a flame retardant assistant and a polyacrylonitrile-based carbon fiber in specific amounts, is free from the above conventional inconveniences.

The present invention has been attained on the basis of the above finding.

### SUMMARY OF THE INVENTION

An object of the present invention is to provide a thermoplastic resin composition which is excellent in stiffness, flame retardancy, fluidity and impact resistance (surface-impact resistance), and capable of forming a molding product having a good appearance.

To attain the above aim, in accordance with the present invention, there is provided a thermoplastic resin composition comprising:

100 parts by weight of a thermoplastic resin containing (A) 5 to 60 parts by weight of a rubber-reinforced resin comprising a graft copolymer produced by polymerizing at least one monomer component (b) selected from the group consisting of aromatic vinyl compounds, cyanided vinyl compounds, acrylate or methacrylate compounds, acid anhydride monomer compounds and maleimide-based compounds in the presence of a rubber-like polymer (a), or a mixture of the graft copolymer with polymers or copolymers of the monomer component (b), said rubber-reinforced resin comprising 5 to 60% by weight of the rubber-like polymer (a) and 40 to 95% by weight of the monomer component (b) with the proviso that the total amount of the components (a) and (b) is 100% by weight, and (B) 40 to 95 parts by weight of an aromatic polycarbonate with the proviso that the total amount of the components (A) and (B) is 100 parts by weight;

(C) 1 to 30 parts by weight of a flame retardant based on 100 parts by weight of the components (A) and (B);

(D) 0.1 to 20 parts by weight of a flame retardant assistant based on 100 parts by weight of the components (A) and (B); and

(E) 1 to 30 parts by weight of a PAN-based carbon fiber based on 100 parts by weight of the components (A) and (B).

In the second aspect of the present invention, there is provided a thermoplastic resin composition comprising:

100 parts by weight of a thermoplastic resin containing (A) 15 to 30 parts by weight of a rubber-reinforced resin comprising a graft copolymer produced by polymerizing at least one monomer component (b) selected from the group consisting of styrene, acrylonitlile, acrylate or methacrylate compounds, acid anhydride monomer compounds and maleimide-based compounds in the presence of a diene-based (co)polymer (a), or a mixture of the graft copolymer with polymers or copolymers of the monomer component (b), said rubber-reinforced resin comprising 5 to 60% by weight of the diene-based (co)polymer (a) and 40 to 95% by weight of the monomer component (b) with the proviso that the total amount of the components (a) and (b) is 100% by weight, and (B) 70 to 85 parts by weight of an aromatic polycarbonate with the proviso that the total amount of the components (A) and (B) is 100 parts by weight;

(C) 10 to 20 parts by weight of a phosphorus-based flame retardant based on 100 parts by weight of the components (A) and (B);

(D) 0.3 to 8 parts by weight of polytetrafluoroethylene based on 100 parts by weight of the components (A) and (B); and

(E) 10 to 20 parts by weight of a PAN-based carbon fiber based on 100 parts by weight of the components (A) and (B); and

(F) 10 to 20 parts by weight of a pitch-based carbon fiber based on 100 parts by weight of the components (A) and (B),

said residual carbon fiber in the composition having an average fiber diameter of 0.05 to 0.7 mm, and

the fluidity (MFR) of the composition being 20 to 70 g/10 minutes when measured at a temperature of 240° C. under a load of 10 kg.

In the third aspect of the present invention, there is provided a thermoplastic resin composition comprising:

100 parts by weight of a thermoplastic resin containing (A) 5 to 60 parts by weight of a rubber-reinforced resin comprising a graft copolymer produced by polymerizing at least one monomer component (b) selected from the group consisting of aromatic vinyl compounds, cyanided vinyl compounds, acrylate or methacrylate compounds, acid anhydride monomer compounds and maleimide-based compounds in the presence of a rubber-like polymer (a), or a mixture of the graft copolymer with polymers or copolymers of the monomer component (b), said rubber-reinforced resin comprising 5 to 60% by weight of the rubber-like polymer (a) and 40 to 95% by weight of the monomer component (b) with the proviso that the total amount of the components (a) and (b) is 100% by weight, and (B) 40 to 95 parts by weight of an aromatic polycarbonate with the proviso that the total amount of the components (A) and (B) is 100 parts by weight;

(C) 1 to 30 parts by weight of a flame retardant based on 100 parts by weight of the components (A) and (B);

(D) 0.1 to 20 parts by weight of a flame retardant assistant based on 100 parts by weight of the components (A) and (B); and

(E) 1 to 30 parts by weight of a PAN-based carbon fiber based on 100 parts by weight of the components (A) and (B),

said component (A) comprising two or more kinds of graft copolymers prepared from two or more kinds of rubber-like polymers (a) which are different in average particle size from each other, and

said aromatic polycarbonate (B) comprising two kinds of aromatic polycarbonates which are different in molecular weight from each other.

### DETAILED DESCRIPTION OF THE INVENTION

The thermoplastic resin composition according to the present invention comprises rubber-reinforced resin (A), aromatic polycarbonate (B), flame retardant (C), flame retardant assistant (D) and PAN-based carbon (E).

First, the rubber-reinforced resin (A) is explained as follows.

The rubber-like polymer (a) constituting the rubber-reinforced resin (A), is not restricted as far as it shows rubber property. As the rubber-like polymers, there may be exemplified diene-based (co)polymers such as polybutadiene, butadiene-styrene copolymer, butadiene-acrylonitrile copolymers, styrene-butadiene-styrene block copolymers, styrene-isoprene-styrene block copolymers, ethylene-propylene-non-conjugated diene copolymers, ethylene-butene-1-non-conjugated diene copolymers, isobutylene-isoprene copolymers, acrylic rubbers or hydrogenated products thereof, polyurethane rubber polyurethane rubbers, silicone rubbers or the like. Of these, polybutadiene, butadiene-styrene copolymer, hydrogenated products of diene-based (co)polymers, ethylene-propylene-non-conjugated diene copolymers, acrylic rubbers and silicone rubbers are preferred. In case where silicone rubbers are used as the rubber-like polymers, it is preferred to use co-condensed product of polyorganosiloxane with graft cross agent such as p-vinylphenylmethyl dimethoxysilane, 2-(p-vinylphenyl)ethylmethyl dimethoxysilane and 2-(p-vinylphenyl(ethylenemethyl dimethoxysilane.

The particle size of the rubber-like polymer latex used as the rubber-like polymer (a), is not particularly restricted. When the component (A) comprises two or more kinds of graft copolymers prepared from two or more kinds of rubber-like polymers (a) which are different in average particle size from each other, it is possible to obtain a thermoplastic resin composition having well-balanced impact resistance and physical properties. The two or more kinds of graft copolymers have, for example, two or more different average particle sizes within (a1) from 80 to 180 nm and within (a2) from more than 180 to 480 nm. In this case, there may be used a graft copolymer produced by polymerizing at least one monomer component (b) selected from the group consisting of aromatic vinyl compounds, cyanided vinyl compounds, acrylate or methacrylate compound, acid anhydride monomer compounds and maleimide-based compounds, in the presence of the rubber-like polymer having at least two different average particle sizes, or a mixture of one graft copolymer produced by polymerizing the rubber-like polymer (a1) with the monomer component (b) and another graft copolymer produced by polymerizing the rubber-like polymer (a2) with the monomer component (b).

Examples of the aromatic vinyl compounds used as the monomer component (b) polymerized with the rubber-like polymer (a) include styrene, α-methyl styrene, o-methyl styrene, p-methyl styrene, vinyl toluene, methyl-α-methyl styrene, bromine-containing styrene or the like. Among these aromatic vinyl compounds, styrene, α-methyl styrene and p-methyl styrene are especially preferred.

Examples of the cyanided vinyl compounds used as the monomer component (b) include acrylonitrile, methacrylonitrile or the like. Among these cyanided vinyl compounds, acrylonitrile is preferred.

Examples of the acrylate or methacrylate ((meth)acrylate) compounds used as the monomer component (b) include methylacrylate, ethylacrylate, butylacrylate, methylmethacrylate, ethylmethacrylate, butylmethacrylate or the like. Among these (meth)acrylate compounds, methylmethacrylate and butylacrylate are preferred.

As the acid anhydride monomer compounds used as the monomer component (b), maleic anhydride is preferably used.

Examples of the maleimide-based compounds used as the monomer component (b) include maleimide, N-methyl maleimide, N-phenyl maleimide, N-(2-methylphenyl)maleimide, N-(4-hydroxyphenyl)maleimide, N-cyclohexyl maleimide or the like. Of these, N-phenyl maleimide, is preferred.

In the production of the graft copolymer used in the present invention, when the rubber-like polymer (a) is graft-polymerized with the monomer component (b), the amount of the rubber-like polymer (a) charged is preferably 20 to 70% by weight, more preferably 25 to 65% by weight, especially preferably 30 to 60% by weight, and the amount of the monomer component (b) charged is preferably 30 to 80% by weight, more preferably 35 to 75% by weight, especially preferably 40 to 70% by weight with the proviso that the total amount of the components (a) and (b) charged is 100% by weight.

Meanwhile, the thus obtained graft copolymer may contain a non-grafted component derived from the monomer component (b) which has been not grafted to the rubber-like polymer (a), i.e., polymers or copolymers of the monomer component (b).

Also, the rubber-reinforced resin (A) may be in the form of a blended mixture of the above graft copolymer with polymers and copolymers obtained by (co)polymerizing the monomer component (b) with the graft copolymer.

Therefore, in the finally obtained rubber-reinforced resin (A), the content of the rubber-like polymer (a) is 5 to 60% by weight, preferably 8 to 60% by weight, more preferably 10 to 50% by weight, and the monomer component (b) is 40 to 95% by weight, preferably 40 to 92% by weight, more preferably 50 to 90% by weight with the proviso that the total amount of the components (a) and (b) is 100% by weight. When the content of the rubber-like polymer (a) in the obtained rubber-reinforced resin (A) is less than 5% by weight, the obtained composition may not exhibit a sufficient impact resistance. When the amount of the rubber-like polymer (a) in the rubber-reinforced resin (A) is more than 60% by weight, the molded product produced from the composition may be deteriorated in appearance and moldability.

The graft ratio of the monomer component (b) in the rubber-reinforced resin (A) is usually in the range of 10 to 200%, preferably 50 to 150% more preferably 60 to 130%, especially preferably 65 to 120%. When the graft ratio is less than 10% small, the obtained molded product may be deteriorated in appearance and impact strength. On the other hand, when the graft ratio is more than 200%, the obtained molded product may be deteriorated in moldability.

Here, the graft ratio (%) is expressed by the value obtained according to the following formula:

Graft ratio (%)=100 x (y−x)/x

wherein x represents the weight of the rubber polymer contained in one gram of the rubber-reinforced resin; and y represents the weight of methyethyketone insoluble component obtained by adding 1 g of the rubber-reinforced resin to 50 ml of methyethyketone, shaking the mixture at room temperature for 2 hours using a shaker, centrifuging the mixture using a centrifugal separator (rotating speed: 15,000 rpm) to separate the insoluble component from a soluble component, and drying it in vacuum at 120° C. for one hour.

The graft copolymer in the rubber-reinforced resin (A) and (co)polymer of the monomer component (b) can be produced by known emulsion polymerization method, solution polymerization method, bulk polymerization method or suspension polymerization method.

In the emulsion polymerization method, there may be used polymerization initiator, chain transfer agent, water or the like. Meanwhile, when the rubber polymer (a) and the monomer component (b) are polymerized to produce the graft copolymer, the monomer component (b) may be added to the reaction system either at a batch, in parts or continuously in the presence of the rubber polymer (a). Also, the combination of the above addition methods may be used for the polymerization. Further, a part or whole of the rubber polymer (a) may be added in the course of the polymerization.

Examples of the polymerization initiators may include cumene hydroperoxide, diisopropylbenzene hydroperoxide, potassium persulfate, AIBN, benzoyl peroxide, lauroyl peroxide, tert-butyl peroxylaurate and tert-butyl peroxymonocarbonate.

Examples of the chain transfer agents may include octyl mercaptan, n-dodecyl mercaptan, tert-dodecyl mercaptan, n-hexyl mercaptan, tetraethyl thiuram sulfide, acrolein, methacrolein, allyl alcohol, 2-ethylhexyl thioglycol, or the like.

Examples of the emulsifiers may include sulfates of higher alcohols, alkylbenzene sulfonates such as sodium dodecylbenzene sulfonate, aliphatic sulfonates such as sodium lauryl sulfate, higher aliphatic carboxylic acid salts, rhodinic acid salts, anionic surfactants such as phosphoric acid-based surfactants, or the like.

When the rubber-reinforced resin is produced by emulsion polymerization, the obtained rubber-reinforced resin may be usually purified by washing a resin powder obtained by the coagulation process using a coagulant, with water and then drying the resin powder. As the coagulants, there may be used inorganic salts such as calcium chloride, magnesium sulfate, magnesium chloride and sodium chloride, and acids such as sulfuric acid and hydrochloric acid.

The above rubber-reinforced resin (A) may be composed of the graft copolymer alone or a blended mixture of two or more kinds of graft copolymers. Alternatively, the rubber-reinforced resin (A) may be in the form of a mixture obtained by blending separately prepared polymers or copolymers of the monomer component (b) with the graft copolymer. In such a case, the amount of the separately prepared polymers or copolymers of the monomer component (b) blended is preferably 10 to 80% by weight, more preferably 15 to 60% by weight based on the weight of the rubber-reinforced resin (A).

The ungrafted-(co)polymer or mixture of the said ungrafted-(co)polymer and (co)polymer of monomer component (b) in the rubber-reinforced resin (A) has an intrinsic viscosity of preferably 0.1 to 1.0 dl/g, more preferably 0.3 to 0.8 dl/g when measured at 30° C. in methyl ethyl ketone. When the intrinsic viscosity of the matrix resin lies within the above-specified range, it is possible to obtain a thermoplastic resin composition having well-balanced impact resistance and moldability (fluidity) because of excellent dispersion of carbon fibers.

The rubber-reinforced resin (A) may be further copolymerized with a functionalized vinyl monomer. Examples of the functional group contained in the functionalized vinyl monomer may include epoxy, hydroxy, carboxyl, amino, amide, oxazoline or the like. Specific examples of the functionalized vinyl monomer may include glycidyl methacrylate, glycidyl acrylate, 2-hydroxyethyl methacrylate, 2-hydroxyethyl acrylate, acrylamide, acrylic acid, methacrylic acid, vinyl oxazoline or the like. When the rubber-reinforced resin (A) is copolymerized with the functionalized vinyl monomer, the interface adhesion (compatibility) between the rubber-reinforced resin (A) and the aromatic polycarbonate (B) or the other thermoplastic resins can be enhanced. Among these functional groups, epoxy and hydroxy are preferred in view of the compatibility with the component (B), and epoxy is more preferred since the epoxy can be reacted with hydroxy end groups of polycarbonate.

Next, the aromatic polycarbonate (B) is explained as follows. As the aromatic polycarbonate (B), there may be used various resins produced, for example, (1) by the reaction between a dihydroxyaryl compound and phosgene or (2) by the transesterification reaction between the dihydroxyaryl compound and diphenyl carbonate.

Examples of the dihydroxyaryl compounds as raw materials of the polycarbonates may include bis(4-hydroxyphenyl)methane, 1,1′-bis(4-hydroxyphenyl)ethane, 2,2′-bis(4-hydroxyphenyl)propane, 2,2′-bis(4-hydroxyphenyl)butane, 4,4′-dihydroxy-3,3′-dimethyldiphenyl ether, 4,4′-dihydroxyphenyl sulfide, 4,4′-dihydroxydiphenyl sulfoxide, 4,4′-dihydroxy-3,3′-dimethyldiphenyl sulfone, hydroquinone, resorcin or the like. These compounds may be used alone or in the form of a mixture of any two or more thereof. One typical example of the aromatic polycarbonate resin is polycarbonate obtained by reacting 2,2′-bis(4-hydroxyphenyl) propane (bisphenol A) with phosgene. The aromatic polycarbonate resins are excellent in heat stability in comparison with aliphatic polycarbonate resins.

The viscosity-average molecular weight of the aromatic polycarbonate (B) is 15,000 to 35,000, preferably 17,000 to 28,000, more preferably 18,000 to 26,000. When the viscosity-average molecular weight of the aromatic polycarbonate (B) is within the above range, the obtained thermoplastic resin composition is further excellent in moldability. Further, when the viscosity-average molecular weight of the aromatic polycarbonate (B) is 17,000 to 22,000, high fluidity property can be imparted to the obtained thermoplastic resin composition. In the present invention, there may also be used two or more kinds of aromatic polycarbonates having different molecular weights. As the aromatic polycarbonate (B), it is preferable to use a polycarbonate having viscosity-average molecular weight of 18,000 to 22,000 and a polycarbonate having viscosity-average molecular weight of 26,000 to 30,000 in combination.

The thermoplastic resin used in the present invention comprises 5 to 60 parts by weight of the rubber-reinforced resin (A) and 40 to 95 parts by weight of the aromatic polycarbonate (B) with the proviso that the total amount of the components (A) and (B) is 100 parts by weight. The amount of the rubber-reinforced resin (A) blended in the thermoplastic resin is preferably 10 to 40 parts by weight, more preferably 15 to 30 parts by weight, and the amount of the aromatic polycarbonate (B) blended is preferably 60 to 90 parts by weight, more preferably 70 to 85 parts by weight. When the amount of the rubber-reinforced resin (A) blended is less than 5 parts by weight, the obtained thermoplastic resin composition may be deteriorated in fluidity. When the amount of the rubber-reinforced resin (A) blended is more than 60 parts by weight, the molded product produced from the composition may be deteriorated in flame retardancy and impact resistance.

As the flame retardant (C), there may be used bromine-based flame retardants and phosphorus-based flame retardants. The use of the phosphorus-based flame retardant is free from environmental problems. When the bromine-based flame retardant is blended in the thermoplastic resin composition, the obtained molded product produced therefrom exhibits a high heat resistance. In the thermoplastic resin composition of the present invention, the bromine-based flame retardant and phosphorus-based flame retardant may be used in combination.

Examples of the bromine-based flame retardants may include tetrabromobisphenol-A oligomers (i.e., brominated epoxy resins having epoxy end groups which may be either non-modified or terminated with tribromophenol, methylalcohol, ethylalcohol or the like), brominated styrene, post-brominated polystyrene, brominated polycarbonate oligomers, tetrabromobisphenol-A, brominated triazine or the like. Among these bromine-based flame retardants, tetrabromobisphenol-A oligomers (i.e., brominated epoxy resins) are preferred, and the tetrabromobisphenol-A oligomers (having a molecular weight of preferably 1,000 to 6,000, more preferably 1,500 to 4,500) terminated with tribromophenol are more preferred. The bromine-based flame retardants have a bromine concentration of preferably 30 to 65% by weight, more preferably 45 to 60% by weight; and a softening point (melting point) of preferably 100 to 180° C., more preferably 110 to 140° C.

Examples of the phosphorus-based flame retardants may include triphenylphosphate, trixylenylphosphate, tricrezylphosphate, trixylenylthiophosphate, condensate of hydroquinone and diphenylphosphate, condensate of resorcinol and diphenylphosphate, condensate of resorcinol and dixylenylphosphate, triphenylphosphate oligomers, condensate of bisphenol-A and diphenylphosphate, condensate of bisphenol-A and dixylenylphosphate or the like. Among these phosphorus-based flame retardants, triphenylphosphate, condensate of resorcinol and dixylenylphosphate (average degree of condensation: 1 to 2), condensate of bisphenol-A and diphenylphosphate (average degree of condensation: 1 to 2), and triphenylphosphate oligomers are preferred. The phosphorus-based flame retardants have a phosphorus concentration of preferably 4 to 30% by weight, more preferably 6 to 25% by weight. The use of the oligomer-type or condensed-type phosphorus-based flame retardants (having two or more phosphorus atoms in one molecule thereof) ensures the production of such a thermoplastic resin composition which is free from contamination of mold. The phosphorus-based flame retardants may be in the form of a liquid at ordinary temperature (23° C.). The liquid phosphorus-based flame retardant is preferably fed to the composition in the course of melt-kneading the composition in an extruder.

In the present invention, the amount of the flame retardant (C) blended is 1 to 30 parts by weight, preferably 5 to 25 parts by weight, more preferably 10 to 20 parts by weight based on 100 parts by weight of the thermoplastic resin composed of the components (A) and (B). When the amount of the flame retardant (C) blended is less than 1 part by weight, it is not possible to impart a sufficient flame retardancy to the composition. When the amount of the flame retardant (C) blended is more than 30 parts by weight, the molded product produced from the composition may be deteriorated in impact resistance.

Examples of the flame retardant assistant (D) may include an antimony compound, polytetrafluoroethylene (PTFE) or the like. The antimony compound is useful as an assistant for the bromine-based flame retardants, and the polytetrafluoroethylene is useful as an assistant for the phosphorus-based flame retardants.

Examples of the antimony compound may include antimony trioxide, antimony pentaxoide or the like.

Also, the polytetrafluoroethylene has an effect of anti-dripping (melt-dropping) upon burning. The polytetrafluoroethylene used has a molecular weight of preferably not less than 500,000, more preferably not less than 1,000,000. An average particle size of polytetrafluoroethylene when mixed and kneeded with the other coponents is preferably 90 to 600 μm, more preferably 100 to 500 μm, still more preferably 120 to 400 μm. After the polytetrafluoroethylene is mixed and kneeded, the polytetrafluoroethylene is dispersed as granular form with an average granular size of 0.1 to 100 μm or as fine fibrous form with a size smaller than the said granular size. When the polytetrafluoroethylene is mixed with the other components, the specific gravity thereof is preferably 1.5 to 2.5, more preferably 2.1 to 2.3; and the bulk density thereof is preferably 0.5 to 1 g/ml, more preferably 0.6 to 0.9 g/ml. When polytetrafluoroethylene is blended, the obtained composition can be effectively prevented from being dripped upon burning as described above and, therefore, can exhibit a higher flame retardancy. Further, the polytetrafluoroethylene may be used in the form of a dispersion prepared by dispersing polytetrafluoroethylene in a solvent such as water or a lubricant such as polyethylene wax, organic acids and organic acid salts such as magnesium stearate.

The amount of the flame retardant assistant (D) blended is 0.1 to 20 parts by weight, preferably 0.2 to 10 parts by weight, more preferably 0.3 to 8 parts by weight based on 100 parts by weight of the thermoplastic resin composed of the components (A) and (B). When the amount of the flame retardant assistant (D) blended is less than 0.1 part by weight, it is not possible to impart a sufficient flame retardancy to the composition. When the amount of the flame retardant assistant (D) blended is more than 20 parts by weight, the molded product produced from the thermoplastic resin composition may be deteriorated in impact resistance and moldability.

In order to impart a high stiffness to the molded product produced from thermoplastic resin composition of the present invention, PAN-based carbon fibers are blended in the composition. When PAN-based carbon fibers are blended therein, it is possible to impart a stiffness to resin materials. In this case, the resin materials can show a satisfactory stiffness, however, the molded product produced therefrom may suffer from defective appearance due to noticeable weld portions formed as protrusion. Therefore, before coating the molded product, it may be required to polish the surface of the molded product in order to remove and flatten the weld portions.

In order to attain both excellent stiffness and appearance, two types of carbon fibers, i.e., PAN-based and pitch-based carbon fibers in combination are preferably blended in the composition. When the combination of two types of carbon fibers, i.e., PAN-based and pitch-based carbon fibers is used for the composition, the obtained molded product not only has flattened weld portions but also exhibits a high stiffness.

The above “PAN-based carbon fiber (E)” is produced by calcining polyacrylonitrile as a raw material. The PAN-based carbon fiber preferably has a fiber diameter of 5 to 15 μm, more preferably 6 to 10 μm. The use of the PAN-based carbon fiber having as small a fiber diameter as possible is preferable from the standpoints of stiffness and appearance of the molded product. Further, the PAN-based carbon fiber preferably has a tensile modulus of 100 to 700 GPa, more preferably 200 to 500 GPa.

In the present invention, the amount of the PAN-based carbon fiber (E) blended is 1 to 30 parts by weight, preferably 5 to 25 parts by weight, more preferably 10 to 20 parts by weight based on 100 parts by weight of the thermoplastic resin composed of the components (A) and (B). When the amount of the PAN-based carbon fiber (E) blended is less than 1 part by weight, it is not possible to impart a sufficient stiffness to the composition. When the amount of the PAN-based carbon fiber (E) blended is more than 30 parts by weight, the molded product produced from the composition may be deteriorated in impact resistance and appearance.

The above “pitch-based carbon fiber (F)” is produced by spinning a raw pitch material into yarns and then heat-treating the spun yarns. The pitch-based carbon fiber preferably has a fiber diameter of 5 to 15 μm, more preferably 8 to 12 μm. The use of the pitch-based carbon fiber having as small a fiber diameter as possible is preferable from the standpoints of stiffness and appearance. Further, the pitch-based carbon fiber preferably has a tensile modulus of 10 to 900 GPa, more preferably 30 to 600 GPa. Usually, carbon fiber is used together with a sizing agent such as epoxy resins, acrylic resins and urethane resins. The amount of sizing agent used in the carbon fiber is about 3 to 9% by weight.

In the present invention, the amount of the pitch-based carbon fiber (F) blended is preferably 1 to 30 parts by weight, more preferably 5 to 25 parts by weight, especially preferably 10 to 20 parts by weight based on 100 parts by weight of the thermoplastic resin composed of the components (A) and (B). When the amount of the pitch-based carbon fiber (F) blended is less than 1 part by weight, it may be insufficient to impart a sufficient stiffness to the composition. When the amount of the pitch-based carbon fiber (E) blended is more than 30 parts by weight, the molded product produced from the composition may be deteriorated in impact resistance and appearance.

In the course of kneading the resin components in a twin-screw extruder, the above two types of the carbon fibers may be separately fed through the extruder, or may be fed thereto in the form of a mixture prepared by preliminarily blending the two type carbon fibers in a tumbler. In the case of the blended mixture, the two type carbon fibers are mixed together in the tumbler at 5 to 20 rpm for about 1 to 3 minutes. When the rotational speed of the tumbler is too high or the mixing time therein is too long, the carbon fibers are disadvantageously split or fibrillated. Upon blending the carbon fibers solely in the tumbler, a lubricant such as polyethylene wax or hardened castor oil may be added thereto in an amount of about 100 to 10,000 ppm based on the carbon fibers in order to prevent the splitting or fibrillation thereof when blended or fed through the twin-screw extruder.

In the present invention, the residual carbon fibers kept in a non-split or non-fibrillated state in the thermoplastic resin composition after kneeding have an average fiber length of preferably 0.05 to 0.70 mm, more preferably 0.10 to 0.50 mm, especially preferably 0.15 to 0.40 mm. When the average fiber length of the residual carbon fibers is less than 0.05 mm, it may be insufficient to impart a sufficient stiffness to the composition. When the average fiber length of the residual carbon fibers is more than 0.70 mm, the obtained composition may be deteriorated in fluidity, and the molded product produced therefrom is deteriorated in appearance. The average fiber length of the residual carbon fibers is measured as follows. That is, the pellets of the thermoplastic resin composition are dissolved in dichloromethane, methyl ethyl ketone or strong acids, and carbon fibers solely are separated from the resultant solution. Then, the thus separated carbon fibers are photographed by an electron microscope, and the obtained microphotograph is analyzed by image processing.

For the purpose of increasing the average fiber length of the residual carbon fibers, it is especially effective to raise the processing temperature used in the twin-screw extruder. The processing temperature is preferably 230 to 270° C., more preferably 240 to 260° C. In addition, the twin-screw extruder preferably has such a screw arrangement provided with a less number of kneading parts. The carbon fibers are preferably fed into the twin-screw extruder at the position closer to the tip end (die-side) thereof.

The thermoplastic resin composition of the present invention has a fluidity (MFR) of preferably 20 to 70 g/10 minutes, more preferably 25 to 65 g/10 minutes, still more preferably 30 to 60 g/10 minutes when measured at 240° C. under a load of 10 kg according to ASTM D1238. When the MFR lies within the above-specified range, it becomes possible to form a 1.5 mm-thick housing for A4-size notebook-type personal computer by using such a mold having only about 1 to 5 pin gates. Notwithstanding the composition exhibits such a low MFR, it is also possible to produce a practically usable molded product having a large thickness only by increasing the number of gates.

The thermoplastic resin composition of the present invention may further contain known fillers in order to impart a sufficient stiffness thereto. Examples of the fillers may include inorganic fillers such as wollastonite, talc, mica, zinc oxide whiskers, calcium titanate whiskers, glass fibers, glass beads or the like. Among these inorganic fillers, talc, mica and glass beads are preferred, and talc is more preferred.

The talc usable in the present invention has an average particle size of preferably 0.5 to 20 =, more preferably 1 to 15 μm, still more preferably 1.3 to 13 μm. When the average particle size of talc used is less than 0.5 μm, the obtained composition tends to be agglomerated upon kneading, resulting in poor appearance of a molded product produced therefrom. When the average particle size of talc used is more than 20 μm, the obtained molded product tends to be deteriorated in impact resistance, physical properties and appearance.

The inorganic fillers may be surface-coated with silane coupling agents. The amount of the silane coupling agent used is 0.1 to 5% by weight, preferably 0.5 to 3% by weight based on the weight of the inorganic filler. Examples of the silane coupling agents may include those containing a functional group such as epoxy, amino, vinyl and hydroxyl. Among these silane coupling agents, those containing an epoxy or amino group are preferred.

When the composition is exposed to high temperature (upon molding), the decomposition reaction of the aromatic polycarbonate may proceed due to residual emulsifier or coagulating agent in the rubber-reinforced resin (A), resulting in deteriorated physical properties of the resin alloy composition. However, when the inorganic phosphorus compound is blended in the composition, the aromatic polycarbonate is inhibited from undergoing the decomposition reaction when exposed to high temperature.

As the inorganic phosphorus compound, potassium dihydrogenphosphate, disodium hydrogenphosphate or hydrate thereof is preferably used. The amount of the inorganic phosphorus compound blended is usually 0.1 to 3 parts by weight, preferably 0.2 to 2 parts by weight based on 100 parts by weight of the thermoplastic resin composition.

In addition, the thermoplastic resin composition of the present invention may contain known additives such as weatherproof agents, antioxidants, plasticizer, lubricants, colorants, anti-static agents and silicone oils. Examples of the weatherproof agents may include phosphorus- or sulfur-containing organic compounds, hydroxy- or vinyl-containing organic compounds such as “SUMILIZER GS” produced by Sumitomo Kagaku Co., Ltd., or the like. Examples of the anti-static agents may include alkyl-containing sulfonates or the like. The amount of the respective additives blended is 0.1 to 10 parts by weight, preferably 0.5 to 5 parts by weight based on 100 parts by weight of the thermoplastic resin composition.

Further, the thermoplastic resin composition of the present invention may contain the other thermoplastic resins or thermosetting resins according to the requirements. Examples of the other thermoplastic resins or thermosetting resins may include polypropylene, polyesters, polysulfones, polyethersulfones, polyphenylsulfides, liquid crystal polymers, styrene-vinylidene acetate copolymers, polyamide elastomers, polyester elastomers, polyetheresteramides, phenol resins, epoxy resins, novolak resins, resol resins or the like. The amount of the other thermoplastic resin or thermosetting resin blended is preferably 1 to 150 parts by weight, more preferably 5 to 100 parts by weight based on 100 parts by weight of the thermoplastic resin composition.

The thermoplastic resin composition of the present invention may be formed into various products by various molding methods such as injection-molding, sheet-extrusion, vacuum-molding, profile-extrusion, foam-molding or the like. The molded products obtained by the above molding methods can be applied to housings for OA devices or domestic electric appliances, especially housings for personal computers, DVD and CD-ROM, or various trays, because of excellent properties thereof. In particular, the molded product obtained from the thermoplastic resin composition of the present invention is suitable as housing for personal computers. Further, the thermoplastic resin composition of the present invention may be printed or marked by a laser-marking method.

The thermoplastic resin composition of the present invention is excellent in moldability, and the molded product produced therefrom is excellent in stiffness, flame retardancy and impact resistance (surface-impact resistance). Therefore, the thermoplastic resin composition of the present invention is an optimum raw material for the production of light-weight, thin-wall molded products.

### EXAMPLES

The present invention will be described in more detail by reference to the following examples. However, these examples are only illustrative and not intended to limit the present invention thereto. Meanwhile, in the following examples and comparative examples, “part” and “%” represent “part by weight” and “% by weight”, respectively, unless otherwise specified. Various properties and characteristics described in the examples and comparative examples were measured and evaluated by the following methods.

(1) Average particle size of rubber-like polymer:

The average particle size of dispersed particles of rubber-like polymer was measured as follows. First, from the observation by an electron microscope, it was confirmed that the particle size of latex previously produced in emulsified state was identical to that of particles dispersed in resin. Then, the particle size of dispersed particles in the latex was measured by light-scattering method. More specifically, the measurement of the particle size was conducted by a cumulant method at a cumulative number of 70 times using a measuring device “LPA-3100” manufactured by Ohtsuka Denshi Co., Ltd.

(2) Graft percentage:

The graft ratio was measured by the same method as described in the present specification.

(3) Intrinsic viscosity [η];

The viscosity of a solution prepared by dissolving a test specimen in methyl ethyl ketone was measured at a temperature of 30° C. using an Ubbellode viscometer.

(4) Viscosity-average molecular weight:

Five methylene chloride solutions of a polycarbonate were prepared and each reduced viscosity thereof was measured at a temperature of 20° C. using an Ubbellode viscometer. From the data of reduced viscosity, intrinsic viscosity thereof was obtained. The viscosity-average molecular weight was calculated from the Mark-Houwink equation (K=1.23×10⁻⁴ and α=0.83).

(5) Izod impact strength:

A notched test specimen was measured according to ASTM D256.

(6) Fluidity (MFR):

The melt flow rate was measured at 240° C. under a load of 10 kg according to ASTM D1238.

(7) Flammability test:

A test specimen having a thickness of 1.0 mm was subjected to flammability test according to “V-rating test” of UL94.

(8) Evaluation of appearance of weld portions:

A molded product having a size of 150 mm×150 mm×2 mm was formed using a mold having two gates at opposite ends thereof, and weld portions thereof were observed to examine whether any protrusions were present thereat. Actually, the molded product was coated with paint, and observed to examine whether or not the weld portions were remarkably noticed.

A: No weld portions were recognized after coating;

B: Weld portions were hardly or only partially recognized after coating;

C: Weld portions were noticeable after coating; and

D: Protruded weld portions were found by finger touch even before coating.

(9) Evaluation of surface impact strength:

Using a Du Pont impact tester, a weight of 200 g was dropped on a test specimen while increasing the drop height from 10 to 50 cm at intervals of 10 cm. The surface impact strength was expressed by the drop height at which the test specimen was broken. The surface impact strength corresponding to a drop height of not less than 30 cm, was determined to be practically acceptable. The thickness of the test specimen used was 2.4 cm.

(10) Evaluation of heat stability:

A molded product having a size of 150 mm×150 mm×2 mm was formed using a mold having two gates at opposite ends thereof at a cylinder temperature of 270° C. and portions close to the gates and weld portions thereof were observed to examine whether any silver streak marks were present thereat.

Good: No silver streak marks were recognized.

Poor: Silver streak marks were found.

Materials used:

(a) Rubber-like polymer:

Polybutadiene latex having an average particle size of 280 nm was used as the rubber-like polymer (a).

(B) Polycarbonate:

B-1: “TOUGHLON FN2200” produced by Idemitsu Sekiyu Kagaku Co., Ltd. (viscosity-average molecular weight: 22,000)

B-2: “TOUGHLON FN3000” produced by Idemitsu Sekiyu Kagaku Co., Ltd. (viscosity-average molecular weight: 29,500)

(C) Flame retardant:

C-1: “PLATHERM EC-20” produced by Dai-Nippon Ink Co., Ltd.; brominated epoxy-based flame retardant (terminated with tribromophenol)

C-2: “PX200” produced by Dai-Hachi Co., Ltd.; condensate of resorcinol and dixylenylphosphate (average degree of condensation: 1.0)

C-3: “FP700” produced by Asahi Denka Kogyo Co., Ltd.; condensate of bisphenol-A and diphenylphosphate (average degree of condensation: 1.1)

(D) Flame retardant assistant:

D-1: Antimony trioxide;

D-2: “TF1620” produced by Hoechst AG. (average particle size: 220 μm; bulk density: 0.85 g/dl)

(E) PAN-based carbon fibers:

“HTA-C6” produced by Toho Rayon Co., Ltd. (fiber diameter: 7 μm; fiber length: 6 mm chopped strands)

(F) Pitch-based carbon fibers:

“K223Y1” produced by Mitsubishi Kagaku Co., Ltd. (fiber diameter: 10 μm; fiber length: 6 mm chopped strands)

(G) Other additives:

Sodium dihydrogenphosphate dihydrate

Preparation of rubber-reinforced resin:

A 7-liter glass flask equipped with a stirrer was charged with 100 parts of ion-exchanged water, 1.5 parts of sodium dodecylbenzenesulfonate, 0.1 part of t-dodecyl mercaptan, 40 parts of polybutadiene (a) latex (calculated as solid content), 15 parts of styrene and 5 parts of acrylonitrile, and the contents of the flask were heated while stirring. At the time at which the temperature reached 45° C., an aqueous activator solution composed of 0.1 part of sodium ethylenediaminetetraacetate, 0.003 part of ferrous sulfate, 0.2 part of formaldehyde sodium sulfoxylate dihydrate and 15 parts of ion-exchanged water, was charged together with 0.1 part of diisopropylbenzenehydroperoxide into the flask, and the contents of the flask were continuously reacted with each other for one hour.

Then, an incremental polymerization component composed of 50 parts of ion-exchanged water, 1 part of sodium dodecylbenzenesulfonate, 0.1 part of t-dodecyl mercaptan, 0.2 part of diisopropylhydroperoxide, 30 parts of styrene and 10 parts of acrylonitrile, was continuously added to the flask for 3 hours while conducting the polymerization reaction therebetween. After completion of addition of the incremental polymerization component, the resultant reaction mixture was further stirred for one hour. Then, after 0.2 part of 2,2-methylene-bis(4-ethylene-6-t-butylphenol) was added to the mixture, the obtained reaction product was taken out from the flask. The latex-like reaction product was solidified by adding diluted sulfuric acid thereto. The obtained solids were sufficiently washed with water and then dried at 75° C. for 24 hours, thereby obtaining a rubber-reinforced resin (A-1) in the form of a white powder. It was confirmed that the obtained rubber-reinforced resin had a polymerization percentage based on added components of 97.2%, a graft ratio of 75% and an intrinsic viscosity of ungrafted-(co)polymer of 0.44 dl/g. The same procedure as defined above was conducted to obtain a rubber-reinforced resin (A-2) and an acrylonitrile-styrene resin (A-3) incorporated into the rubber-reinforced resin (refer to Table 1).

TABLE 1

| | Rubber-reinforced resin | | AS resin |
|---|---|---|---|
| A-1 | | A-2 | A-3 |
| First-stage | | | |
| polymerization | | | |
| components | | | |
| Polybutadiene (wt. %) | 40 | 40 | — |
| Styrene (wt. %) | 15 | 15 | 73 |
| Acrylonitrile (wt. %) | 5 | 5 | 27 |
| Second-stage | | | |
| polymerization | | | |
| components | | | |
| Styrene (wt. %) | 30 | 30 | — |
| Acrylonitrile (wt. %) | 10 | 10 | — |
| Intrinsic viscosity | 0.44 | 0.38 | 0.50 |
| (dl/g) | | | |
| Graft ratio (%) | 75 | 50 | — |

### Examples 1 to 8 and Comparative Examples 1 to 5

The above-mentioned component (A) and the below-mentioned components (B) to (G) were blended together at mixing ratios shown in Tables 2 and 3 at a temperature of 230 to 250° C. using a twin-screw extruder (“TEM50” manufactured by Toshiba Kikai Co., Ltd.), and then extruded into pellets. In case where two types of carbon fibers were used, they were previously blended together using a tumbler, and fed to a mixture of the above components (A) to (F) through a twin-screw extruder in the course of kneading the mixture. The thus obtained pellets were injection-molded at a molding temperature of 230° C. to obtain a test specimen for evaluation tests. Meanwhile, average fiber lengths of the residual carbon fibers as shown in Tables 2 and 3 were evaluated by measuring those of the carbon fibers contained in the pellets.

TABLE 2

| | Ex. 1 | Ex. 2 | Ex. 3 | Ex. 4 |
|---|---|---|---|---|
| Composition (wt. part) | | | | |
| A (A-1) | 20 | 15 | — | 15 |
| (A-2) | — | — | — | — |
| (A-3) | 20 | | 20 | 10 |
| B (B-1): Polycarbonate | 60 | 85 | 60 | 75 |
| (B-2) Polycarbonate | — | — | — | — |
| C (C-1): Brominated | 15 | — | 15 | 14 |
| epoxy resin | | | | |
| (C-2) PX200 | — | 18 | — | 7 |
| (C-3) FP700 | — | — | — | — |
| D (D-1): Antimony | 6 | — | 6 | — |
| trioxide | | | | |
| (D-2): PTFE | — | 0.3 | — | 0.5 |
| E PAN-based carbon fiber | 15 | 13 | 15 | 15 |
| F Pitch-based carbon | 15 | 10 | 15 | 20 |
| fiber | | | | |
| G sodium dihydrogen | 0.2 | 0.2 | 0.2 | 0.2 |
| phosphate | | | | |
| Evaluation of thermoplastic | | | | |
| resin composition | | | | |
| Izod impact strength | 98 | 86 | 75 | 94 |
| (J/m) | | | | |
| Fluidity (g/10 min.) | 38 | 58 | 45 | 50 |
| Heat deformation | 98 | 91 | 93 | 93 |
| temperature (° C.) | | | | |
| Flexural modulus (MPa) | 12,800 | 8,500 | 12,900 | 11,700 |
| Flame retardancy | V-0 | V-0 | V-0 | V-0 |
| Appearance of weld | B | A | B | A |
| portions | | | | |
| Surface impact strength | 40 | 40 | 30 | 40 |
| (cm) | | | | |
| Average fiber length of | 0.25 | 0.28 | 0.29 | 0.18 |
| residual carbon fiber | | | | |
| (mm) | | | | |
| Heat stability | Good | Good | Good | Good |
| | Ex. 5 | Ex. 6 | Ex. 7 | Ex. 8 |
| Composition (wt. part) | | | | |
| A (A-1) | 20 | 15 | 12 | 15 |
| (A-2) | — | — | — | — |
| (A-3) | 10 | 10 | — | 10 |
| B (B-1): Polycarbonate | 40 | — | 44 | 50 |
| (B-2) Polycarbonate | 30 | 75 | 44 | 20 |
| C (C-1): Brominated | 15 | 14 | — | — |
| epoxy resin | | | | |
| (C-2) PX200 | — | — | 24 | — |
| (C-3) FP700 | — | — | — | 20 |
| D (D-1): Antimony | 5 | 7 | — | — |
| trioxide | | | | |
| (D-2): PTFE | — | — | — | — |
| E PAN-based carbon fiber | 10 | 15 | 19 | 10 |
| F Pitch-based carbon | 13 | 15 | — | 10 |
| fiber | | | | |
| G sodium dihydrogen | 0.2 | 0.2 | 0.2 | 0.2 |
| phosphate | | | | |
| Evaluation of thermoplastic | | | | |
| resin composition | | | | |
| Izod impact strength | 115 | 94 | 75 | 86 |
| (J/m) | | | | |
| Fluidity (g/10 min.) | 25 | 22 | 30 | 45 |
| Heat deformation | 97 | 97 | 90 | 89 |
| temperature (° C.) | | | | |
| Flexural modulus (MPa) | 9,500 | 11,500 | 7,500 | 8,000 |
| Flame retardancy | V-0 | V-0 | V-0 | V-0 |
| Appearance of weld | B | B | C | B |
| portions | | | | |
| Surface impact strength | 50 | 40 | 40 | 50 |
| (cm) | | | | |
| Average fiber length of | 0.27 | 0.19 | 0.23 | 0.24 |
| residual carbon fiber | | | | |
| (mm) | | | | |
| Heat stability | Good | Good | Good | Good |

TABLE 3

| | Com. | Com. | Com. | Com. | Com. |
|---|---|---|---|---|---|
| | Ex. 1 | Ex. 2 | Ex. 3 | Ex. 4 | Ex. 5 |
| Composition (wt. part) | | | | | |
| A (A-1) | 20 | 20 | 20 | 20 | 20 |
| (A-2) | — | — | — | — | |
| (A-3) | 60 | 20 | 20 | 20 | 20 |
| B (B-1): Polycarbonate | 20 | 60 | 60 | 60 | 60 |
| (B-2): Polycarbonate | — | — | — | — | |
| C (C-1) Brominated | 15 | 15 | 15 | 15 | 40 |
| epoxy resin | | | | | |
| (C-2) PX200 | | | | | |
| D (D-1): Antimony | 6 | 6 | 6 | 6 | 25 |
| trioxide | | | | | |
| (D-2): PTFB | — | — | — | — | — |
| E PAN-based carbon | 15 | 35 | — | 35 | 15 |
| fiber | | | | | |
| F Pitch-based carbon | 15 | — | 30 | 35 | 15 |
| fiber | | | | | |
| G Sodium dihydrogen | — | — | — | — | — |
| phosphate | | | | | |
| Evaluation of | | | | | |
| thermoplastic | | | | | |
| resin composition | | | | | |
| Izod impact strength | 65 | 78 | 95 | 63 | 37 |
| (J/m) | | | | | |
| Fluidity (g/10 min.) | 52 | 37 | 38 | 27 | 43 |
| Heat deformation | 97 | 98 | 98 | 98 | 95 |
| temperature (° C.) | | | | | |
| Flexural modulus (MPa) | 13,000 | 14,500 | 12,300 | 16,000 | 10,400 |
| Flame retardancy | V-0 | V-0 | V-0 | V-0 | V-0 |
| Appearance of weld | B | D | C | D | C |
| portions | | | | | |
| Surface impact strength | 10 | 20 | 40 | 20 | 10 |
| (cm) | | | | | |
| Average fiber length of | 0.28 | 0.24 | 0.25 | 0.15 | 0.31 |
| residual carbon fiber | | | | | |
| Heat resistance | Poor | Poor | Poor | Poor | Poor |

From the results shown in Table 2, it was confirmed that the thermoplastic resin compositions of the present invention all were excellent in stiffness, fluidity, impact resistance (surface impact resistance) and flame retardancy.

What is claimed is:

1. A thermoplastic resin composition comprising:
100 parts by weight of a thermoplastic resin containing (A) 5 to 60 parts by weight of a rubber-reinforced resin comprising a graft copolymer produced by polymerizing at least one monomer component (b) selected from the group consisting of aromatic vinyl compounds, cyanided vinyl compounds, acrylate or methacrylate compounds, acid anhydride monomer compounds and maleimide-based compounds in the presence of a rubber-like polymer (a), or a mixture of the graft copolymer with polymers or copolymers of the monomer component (b), said rubber-reinforced resin comprising 5 to 60% by weight of the rubber-like polymer (a) and 40 to 95% by weight of the monomer component (b) with the proviso that the total amount of the components (a) and (b) is 100% by weight, and (B) 40 to 95 parts by weight of an aromatic polycarbonate with the proviso that the total amount of the components (A) and (B) is 100 parts by weight;
(C) 1 to 30 parts by weight of a flame retardant based on 100 parts by weight of the components (A) and (B);
(D) 0.1 to 20 parts by weight of a flame retardant assistant based on 100 parts by weight of the components (A) and (B); and
(E) 1 to 30 parts by weight of a PAN-based carbon fiber based on 100 parts by weight of the components (A) and (B).

2. A thermoplastic resin composition according to claim 1, further comprising
(F) 1 to 30 parts by weight of a pitch-based carbon fiber based on 100 parts by weight of the components (A) and (B).

3. A thermoplastic resin composition according to claim 1, wherein the residual carbon fiber in the composition has an average fiber diameter of 0.05 to 0.7 mm.

4. A thermoplastic resin composition according to claim 1, wherein the fluidity (MFR) of the composition is 20 to 70 g/10 minutes when measured at a temperature of 240° C. under a load of 10 kg.

5. A thermoplastic resin composition according to claim 1, wherein the flame retardant (C) is a bromine-based flame retardant or a phosphorus-based flame retardant.

6. A thermoplastic resin composition according to claim 1, wherein the flame retardant assistant (D) is an antimony compound or polytetrafluoroethylene.

7. A thermoplastic resin composition according to claim 1, wherein the flame retardant (C) is a bromine-based flame retardant, and the flame retardant assistant (D) is an antimony compound.

8. A thermoplastic resin composition according to claim 1, wherein the flame retardant (C) is a phosphorus-based flame retardant, and the flame retardant assistant (D) is polytetrafluoroethylene.

9. A thermoplastic resin composition according to claim 1, wherein the rubber-reinforced resin (A) has a graft ratio of 10 to 200%.

10. A thermoplastic resin composition according to claim 1, wherein the component (A) comprises two or more kinds of graft copolymers prepared from two or more kinds of rubber-like polymers (a) which are different in average particle size from each other.

11. A thermoplastic resin composition according to claim 10, wherein the rubber-like polymer (a) comprises two or more kinds of particles comprising particles having an average particle size within 80 to 180 nm, and other particles having an average particle size within from more than 180 to 480 nm.

12. A thermoplastic resin composition according to claim 1, wherein the aromatic polycarbonate (B) comprises two kinds of aromatic polycarbonates which are different in molecular weight from each other.

13. A thermoplastic resin composition according to claim 12, wherein the two kinds of aromatic polycarbonates have viscosity-average molecular weights of from 18,000 to 22,000 and from 26,000 to 30,000, respectively.

14. A thermoplastic resin composition according to claim 1, further comprising an inorganic phosphorus compound (G).

15. A thermoplastic resin composition comprising:
100 parts by weight of a thermoplastic resin containing (A) 15 to 30 parts by weight of a rubber-reinforced resin comprising a graft copolymer produced by polymerizing at least one monomer component (b) selected from the group consisting of styrene, acrylonitlile, acrylate or methacrylate compounds, acid anhydride monomer compounds and maleimide-based compounds in the presence of a diene-based (co)polymer (a), or a mixture of the graft copolymer with polymers or copolymers of the monomer component (b), said rubber-reinforced resin comprising 5 to 60% by weight of the diene-based (co)polymer (a) and 40 to 95% by weight of the monomer component (b) with the proviso that the total amount of the components (a) and (b) is 100% by weight, and (B) 70 to 85 parts by weight of an aromatic polycarbonate with the proviso that the total amount of the components (A) and (B) is 100 parts by weight;
(C) 10 to 20 parts by weight of a phosphorus-based flame retardant based on 100 parts by weight of the components (A) and (B);
(D) 0.3 to 8 parts by weight of polytetrafluoroethylene based on 100 parts by weight of the components (A) and (B); and
(E) 10 to 20 parts by weight of a PAN-based carbon fiber based on 100 parts by weight of the components (A) and (B); and
(F) 10 to 20 parts by weight of a pitch-based carbon fiber based on 100 parts by weight of the components (A) and (B),
said residual carbon fiber in the composition having an average fiber diameter of 0.05 to 0.7 mm, and
the fluidity (MFR) of the composition being 20 to 70 g/10 minutes when measured at a temperature of 240° C. under a load of 10 kg.

16. A thermoplastic resin composition comprising:
100 parts by weight of a thermoplastic resin containing (A) 5 to 60 parts by weight of a rubber-reinforced resin comprising a graft copolymer produced by polymerizing at least one monomer component (b) selected from the group consisting of aromatic vinyl compounds, cyanided vinyl compounds, acrylate or methacrylate compounds, acid anhydride monomer compounds and maleimide-based compounds in the presence of a rubber-like polymer (a), or a mixture of the graft copolymer with polymers or copolymers of the monomer component (b), said rubber-reinforced resin comprising 5 to 60% by weight of the rubber-like polymer (a) and 40 to 95% by weight of the monomer component (b) with the proviso that the total amount of the components (a) and (b) is 100% by weight, and (B) 40 to 95 parts by weight of an aromatic polycarbonate with the proviso that the total amount of the components (A) and (B) is 100 parts by weight;
(C) 1 to 30 parts by weight of a flame retardant based on 100 parts by weight of the components (A) and (B);
(D) 0.1 to 20 parts by weight of a flame retardant assistant based on 100 parts by weight of the components (A) and (B); and
(E) 1 to 30 parts by weight of a PAN-based carbon fiber based on 100 parts by weight of the components (A) and (B),
said component (A) comprising two or more kinds of graft copolymers prepared from two or more kinds of rubber-like polymers (a) which are different in average particle size from each other, and
said aromatic polycarbonate (B) comprising two kinds of aromatic polycarbonates which are different in molecular weight from each other.
